(19) United States
(12) Patent Application Publication
(10) Pub. No.: US 2005/0062941 A1
(43) Pub. Date: Mar. 24, 2005

(54) Projection-type display apparatus and method for enhancing image quality

(76) Inventor: Chen-Cheng Huang, Taoyuan City (TW)

Correspondence Address: SNELL & WILMER;ONE ARIZONA CENTER, 400 EAST VAN BUREN, PHOENIX, AZ, 850040001, US

(21) Appl. No.: 10/946,805

(22) Filed: Sep. 22, 2004

(30) Foreign Application Priority Data
Sep. 23, 2003 (TW) 92126190

(51) Int. Cl. G03B 21/28

(52) U.S. Cl. 353/81

(57) ABSTRACT

A projection-type display apparatus and a method for adjusting an output image are provided. The projection-type display apparatus includes a light source, a color separation device, and a driving device. The color separation device includes a plurality of filters for filtering a light beam provided by the light source so as to selectively form a plurality of chromatic lights corresponding to the filters. The driving device drives the color separation device to selectively increase and decrease a rotation speed of a predetermined one of the filters so as to control a time period of the predetermined filter spinning through the light beam.

### CROSS-REFERENCE TO RELATED APPLICATIONS

This application claims priority to Taiwan Patent Application No. 092126190 entitled “Display Apparatus and method for Adjusting Tone of Image”, filed on Sep. 23, 2003, which is incorporated herein by reference.

### FIELD OF INVENTION

The present invention generally relates to a projection-type display apparatus and a method for adjusting an image, and more particularly, to a projection-type display apparatus capable of adjusting image quality and a method thereof.

### BACKGROUND OF THE INVENTION

The full color display systems of today generally form images by combining three projected primary colors, namely red, green, and blue, to form a full color image to the eyes of the viewers. In parallel with the progress of business activities and the development of interactive learning, projectors become indispensable image forming apparatuses in various kinds of business events. Therefore, the image displaying technology is advancing from the liquid crystal display to the digital light processing (DLP). The digital light processing technology employs the reflected light, which is modulated by the spatial light modulator (SLM), such as commonly known digital micromirror device (DMD). The DLP technology offers higher resolution and is often used in direct-view or projection-type display apparatus.

The digital micromirror device consists of hundreds or thousands of micromirrors, and one mirror corresponds to one image pixel. With the aid of a digital micromirror device and proper filters, the image display system may form images consisting of three primary colors by a single light source. The spatial light modulators adopt sequential color filters to form color images. All image pixels are formed by light respectively filtrated by the filters. Such display systems typically use a color separation device having red, green, and blue filters as the sequential color filter to form full color images. Therefore, light is filtrated by the color separation device to form corresponding colors and projected into the spatial light modulator to form image pixels.

Typical color separation devices are disk-like color wheels with a plurality of filters. However, there are other options, e.g. rotatable drum-like or polygonal color separation devices. While projecting into the color separation device, the white light beam is filtrated by the filters to result in light beam of one of the three primary colors. The color separation device generally includes at least one filter for each primary color.

Typically, the rotation speed of the color separation device should be high enough, allowing at least one primary color image to create persistence. Color separation devices with higher rotation speed or more filters may moderate undesired discontinuity of output image. The three primary color lights combine to form a white light. But such combined white light is not bright enough for data-type images (static images). To this end, color separation devices with red, green, blue, and white filters are devised. However, the conventional display apparatus with such a color separation device generally outputs images with a predetermined logic ratio for each color, resulting in low color saturation while outputting motion picture images.

It is therefore desirable to provide a display apparatus and a method for allowing adjustment of image quality.

### SUMMARY OF THE INVENTION

One aspect of the present invention is to provide a projection-type display apparatus with optimized image quality, such as brightness, hue or color saturation, with respect to conditions of the environment or the visual requirements of users.

Another aspect of the present invention is to provide a projection-type display apparatus capable of being selectively operated in several control modes, such as a dynamic mode and a static mode, so that the color saturation or brightness of image is adjustable for different occasions.

A further aspect of the present invention is to provide a projection-type display apparatus, which controls the rotation speeds of filters of a color separation device so as to control the time period of each filter spinning through the light beam resulting in the optimization of image quality, such as brightness, hue or color saturation.

In one embodiment, the present invention provides a projection-type display apparatus including a light source, a color separation device, and a driving device. The color separation device can be, for example, a color wheel or a color drum, which includes a plurality of filters, such as red, blue, green, and white filters. When the light source provides a light beam projecting on the color separation device, the color separation device filters the light beam to selectively form a plurality of chromatic lights, such as red, blue, green, and white lights, corresponding to the filters. The driving device is configured to drive the color separation device and control its rotation. The driving device selectively increases and decreases a rotation speed of a predetermined one of the filters so as to control a time period of the predetermined filter spinning through the light beam.

A further aspect of the present invention is to provide a projection-type display apparatus, which outputs an image with enhanced brightness or color saturation by controlling the rotation speed of the white filter. In an exemplary embodiment, the driving device controls the rotation speed of the white filter in a plurality of modes, such as a normal mode, a first mode, and a second mode. When the display apparatus is operated in the first mode, the white filter rotates faster than it does in the normal mode so as to form an image with enhanced color saturation, and therefore the display apparatus is suitable for outputting dynamic images. When the display apparatus is operated in the second mode, the white filter rotates slower than it does in the normal mode so as to form an image with enhanced brightness.

Furthermore, in another exemplary embodiment, the driving device controls the rotation speed of the predetermined filter in several modes, such as a warm color mode and a cold color mode, which adjusts the hue of image by controlling the rotation speed of the red filter. The display apparatus further includes an operating interface for manually adjusting the rotation speed of the predetermined filter.

Another aspect of the present invention is to provide a method for adjusting an image output by a display apparatus. The display apparatus includes a color separation device having a plurality of filters. In one embodiment, the method includes a step of providing a light beam incident on the color separation device so as to selectively form a plurality of chromatic lights corresponding to the filters. The color separation device is driven to control a rotation speed of a predetermined one of the filters so that at least two filters rotate at different speeds when spinning through the light beam.

In an exemplary embodiment, the filters include at least one white filter and at least one chromatic filter. For forming an image with enhanced color saturation, the rotation speed of the white filter is increased when the light beam is incident on the white filter. Alternatively, for forming an image with enhanced brightness, the rotation speed of the white filter is decreased when the light beam is incident on the white filter. Furthermore, the chromatic filter can be a red filter. For forming an image of cold color, the rotation speed of the red filter is increased when the light beam is incident on the red filter. Alternatively, the rotation speed of the red filter can be decreased to form an image of warm color.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a projection-type display apparatus in accordance with a first embodiment of the present invention;

FIG. 2 illustrates a projection-type display apparatus in accordance with a second embodiment of the present invention; and

FIG. 3 illustrates a flowchart of a method for adjusting an image in accordance with one embodiment of the present invention.

### DETAILED DESCRIPTION

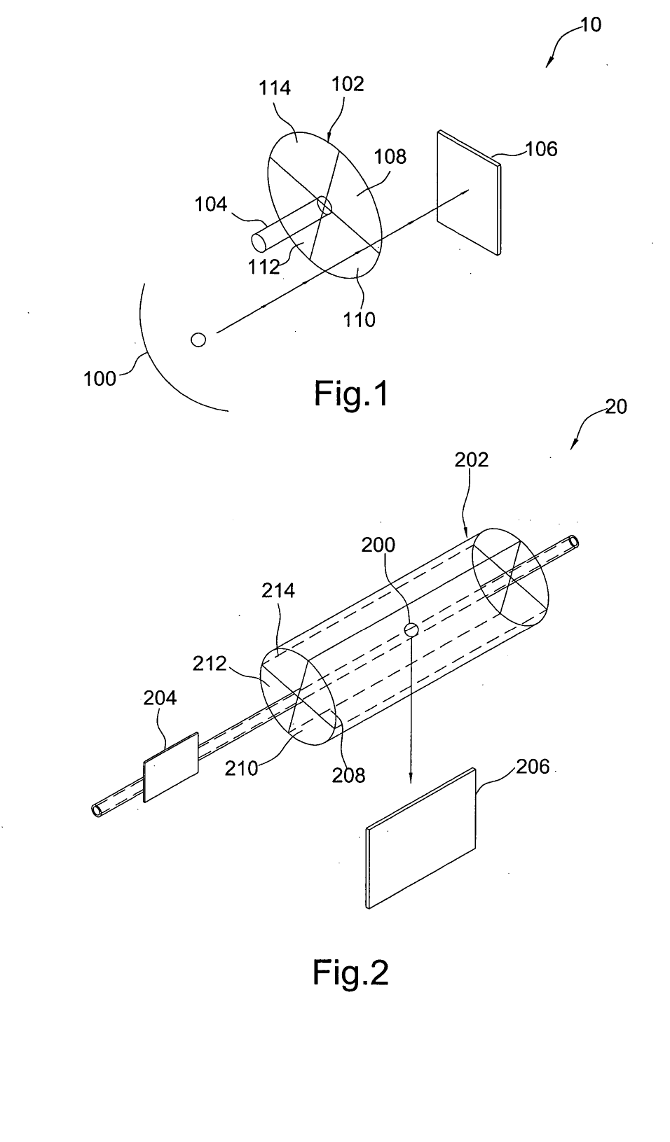

The present invention provides a projection-type display apparatus and a method for adjusting output image, which can be operated in several modes, such as a dynamic mode or a static mode, so as to optimize image quality, such as brightness, hue or color saturation, with respect to conditions of the environment or the visual requirements of users. FIGS. 1-3 illustrate preferred embodiments of the present invention.

Referring to FIG. 1, the present invention provides a projection-type display apparatus 10, which includes a light source 100, a color separation device 102, and a driving device 104. The projection-type display apparatus 10 can be, for example, a digital light processing projector, which adjusts the deflection angle of a reflection mirror 106 so that a light beam passing through the color separation device 102 is reflected to form an image on a target screen in accordance with the image signals. In this embodiment, the light source 100 provides a light beam. The color separation device 102 includes a plurality of filters. When the light beam impinges on the color separation device 102, the light beam is filtered to selectively form a plurality of chromatic lights corresponding to the filters. The driving device 104 drives the color separation device 102 to rotate and selectively adjust the rotation speed of the color separation device 102. For example, the driving device 104 selectively increases and decreases a rotation speed of a predetermined one of the filters so as to control a time period of the predetermined filter spinning through the light beam.

As shown in FIG. 1, in an exemplary embodiment, the color separation device 102 can be a color wheel, which includes 4 filters, such as 3 filters of primary color (red filter 108, green filter 110 and blue filter 112) and a white filter 114. When the light is incident on the color separation device 102, the driving device 104 drives the color separation device 102 to rotate so that filters of different colors 108-114 are sequentially spinning through the light beam to selectively form chromatic lights, such as red light, green light, blue light and white light, which respectively correspond to the filters 108, 110, 112 and 114. One aspect of the present invention is using the driving device 104 to adjust the rotation speed of at least one of the filters so as to control the time period of the predetermined filter spinning through the light beam different from those of other filters. Therefore, the hue, brightness, or color saturation of an output image can be adjusted using different display modes.

For example, by controlling the time period that the white filter 112 spins through the light beam, the brightness of an image can be adjusted. In an exemplary embodiment, the driving device 104 controls the rotation speed of the white filter 112 in several modes including a normal mode, a first mode, and a second mode. The normal mode can be a default operation mode, in which the white filter 112 rotates at a first speed (default speed). The first mode and the second mode can be control modes respectively for operation in a bright environment and a dim environment. In the first mode (bright environment mode), the white filer 112 rotates at a second speed, which is greater than the first speed, so that an image with enhanced color saturation can be formed. In the second mode (dim environment mode), the white filter 112 rotates at a third speed, which is slower than the first speed, so that an image with enhanced brightness can be formed.

In other words, when the projection-type display apparatus is operated to output static images, users generally have low requirements for the color saturation and brightness of images. Therefore, the driving device 104 drives the white filter 112 to rotate in the normal mode. When the projection-type display apparatus 10 is operated to output dynamic images, such as motion pictures, in a bright environment, or in occasions demanding images with enhanced color saturation, the driving device 104 drives the white filter 112 to rotate in the first mode. Therefore, the white filter 112 spins through the light beam at a faster speed as well as in less time period so that its logic ratio in a full color projection system is decreased. Accordingly, the logic ratios of other chromatic lights are relatively increased so that the color saturation of an output image is enhanced. When the projection-type display apparatus 10 is operated in a dim environment or in occasions demanding images with enhanced brightness, the driving device 104 drives the white filter 112 to rotate in the second mode. Therefore, the white filter 112 spins through the light beam at a slower speed as well as in longer time period so that its logic ratio in a color projection system is increased. Accordingly, the brightness of an image is enhanced.

Furthermore, by controlling the rotation speed of a chromatic filter, such as the red filter 108, the time period of the chromatic filter spinning through the light beam can be adjusted. In another exemplary embodiment, the driving device 104 controls the rotation speed of the predetermined filter in several modes, such as a warm color mode and a cold color mode. For example, in the warm color mode, the driving device 104 controls the color separation device 102 to rotate so that the red filter 108 rotates at a speed slower than the green filter 110, the blue filter 112 and the white filter do. Therefore, an image of warm color is formed. In other words, the driving device 104 reduces the rotation speed so that the time period of the red filter 108 spinning through the light beam is increased resulting in the increase of the logic ratio in the full color projection system. Alternatively, the rotation speeds of the green filter 110, the blue filter 112 and the white filter 114 can be increased with respect to the rotation speed of the red filter 108, so that the logic ratio of the red filter 108 is relatively increased. In the cold color mode, the driving device 104 drives the color separation device 102 to rotate so that the red filter 108 rotates at a speed faster than the green filter 110, the blue filter 112 and the white filter 114 do. Therefore, an image of cold color can be formed. In other words, by increasing the rotation speed of the red filter 108, or by decreasing the rotation speeds of the green filter 110, the blue filter 112, and the white filter 114, the cold color image can be obtained.

The projection-type display apparatus 10 further includes an operation interface for manually adjusting the rotation speeds of the filters. In other words, the projection-type display apparatus 10 can be designed to manually adjust the output image according to a user's preference. For example, the operation modes described above can be built in the projection-type display apparatus. The operation interface has multiple options respectively corresponding to the operation modes. The user can select the preferable operation mode to obtain the most appropriate image. In this case, each filter has a predetermined rotation speed corresponding to each mode. Once a specific mode is selected, the brightness, hue and color saturation of the image are accordingly determined. Furthermore, the projection-type display apparatus can be designed to manually adjust the rotation speed of one or more filters. For example, the operation interface has multiple options respectively corresponding to the filters. The user can select to adjust the rotation speed of one or more filters so as to obtain the most preferable image. In this case, each filter has a default rotation speed. The user can adjust the output image by manually increasing or decreasing the rotation speed of a corresponding filter.

Referring to FIG. 2, in a second embodiment, the present invention provides a projection-type display apparatus 20, which includes a light source 200, a color separation device 202 and a driving device 204. The projection-type display apparatus 20 can be, for example, a digital light processing projector, which adjusts the deflection angle of a reflection mirror 206 so that a light beam passing through the color separation device 202 is reflected to form an image on a target screen in accordance with the image signals. In this embodiment, the light source 200 provides a light beam. The color separation device 202 includes a plurality of filters. When the light beam impinges on the color separation device 202, the light beam is filtered to selectively form a plurality of chromatic lights corresponding to the filters. The driving device 204 drives the color separation device 202 to rotate and selectively adjust the rotation speed of the color separation device 202. For example, the driving device 204 selectively increases and decreases a rotation speed of a predetermined one of the filters so as to control a time period of the predetermined filter spinning through the light beam. Different from the first embodiment, the color separation device 202 is a color drum, which has 4 filters, such as red filter 208, green filter 210, blue filter 212, and white filter 214. In this embodiment, the light source 202 is positioned within the color drum 202. The driving device 204 can control the color separation device 202 to rotate in a similar way or in a similar operation mode as described in the first embodiment.

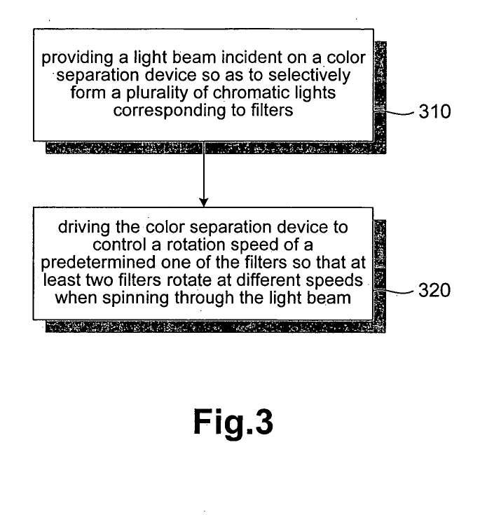

Referring to FIG. 3, in another embodiment, the present invention provides a method for adjusting an image output by a projection-type display apparatus. The projection-type display apparatus includes a color separation device with a plurality of filters, such as a color wheel or a color drum. The method includes providing a light beam incident on the color separation device so as to selectively form a plurality of chromatic lights corresponding to the filters (step 310). In step 320, the color separation device is driven to control a rotation speed of a predetermined one of the filters so that at least two filters rotate at different speeds when spinning through the light beam.

For example, the filters include at least one white filter and at least one chromatic filter. When the light beam is incident on the white filter, the rotation speed of the white filter is increased so as to form an image with enhanced color saturation. Alternatively, when the light beam is incident on the white filter, the rotation speed of the white filter is decreased to form an image with enhanced brightness. In other words, by adjusting the rotation speed when the light beam is projected on the white filter, the time period of the white filter spinning through the light beam can be controlled so as to optimize the brightness or color saturation of an output image. In another exemplary embodiment, the chromatic filters include at least one red filter and other color filters, such as a green filter and a blue filter. When the light is incident on the red filter, the rotation speed of the red filter can be decreased so as to form an image of warm color. When the light beam is incident on the red filter, the rotation speed of the red filter can be increased so as to form an image of cold color. In other words, by adjusting the rotation speed of the chromatic filter, such as the red filter, the time period of the chromatic filter spinning through the light beam is controlled so as to adjust the hue of an output image.

It is noted that the number and the color of filters of the color separation device can vary with different design needs and are not limited to 4 filters and each of specific color as illustrated embodiments of FIGS. 1 and 2.

Although specific embodiments have been illustrated and described, it will be obvious to those skilled in the art that various modifications may be made without departing from what is intended to be limited solely by the appended claims.

1. A projection-type display apparatus, comprising:
a light source for providing a light beam;
a color separation device comprising a plurality of filters for filtering said light beam to selectively form a plurality of chromatic lights corresponding to said filters; and
a driving device for driving said color separation device;
wherein said driving device selectively increases and decreases a rotation speed of a predetermined one of said filters so as to control a time period of said predetermined filter spinning through said light beam.

2. The projection-type display apparatus of claim 1, wherein said filters comprise a red filter, a green filter, a blue filter and a white filter.

3. The projection-type display apparatus of claim 2, wherein said predetermined filter is said white filter, and said driving device controls said rotation speed of said white filter in a plurality of modes comprising:
a normal mode, wherein said white filter rotates at a first speed; and
a first mode, wherein said white filter rotates at a second speed, and said second speed is greater than said first speed so as to form an image with enhanced color saturation.

4. The projection-type display apparatus of claim 3, wherein said projection-type display apparatus in said first mode outputs a dynamic image.

5. The projection-type display apparatus of claim 3, wherein said projection-type display apparatus in said normal mode outputs a static image.

6. The projection-type display apparatus of claim 2, wherein said predetermined filter is said white filter, and said driving device controls said rotation speed of said white filter in a plurality of modes comprising:
a normal mode, wherein said white filter rotates at a first speed; and
a second mode, wherein said white filter rotates at a third speed, and said third speed is slower than said first speed so as to form and image with enhanced brightness.

7. The projection-type display apparatus of claim 2, wherein said driving device controls said rotation speed of said predetermined filter in a plurality of modes comprising:
a warm color mode, wherein said red filter rotates at a speed slower than said green filter, said white filter, and said blue filter do; and
a cold color mode, wherein said red filter rotates at a speed faster than said green filter, said white filter, and said blue filter do.

8. The projection-type display apparatus of claim 1, further comprising an operating interface provided for manually adjusting said rotation speed of said predetermined filter.

9. The projection-type display apparatus of claim 1, wherein said color separation device comprises a color wheel.

10. The projection-type display apparatus of claim 1, wherein said color separation device comprises a color drum.

11. A projection-type display apparatus, comprising:
a light source for providing a light beam;
a color separation device comprising a plurality of filters comprising a red filter, a green filter, a blue filter and a white filter for filtering said light beam to selectively form a plurality of chromatic lights corresponding to said filters;
a driving device for driving said color separation device; and
an operating interface provided for manually controlling a rotation speed of a predetermined one of said filters;
wherein said operating interface provides a plurality of control modes comprising:
a normal mode, wherein said white filter rotates at a first speed;
a first mode, wherein said white filter rotates at a second speed, and said second speed is greater than said first speed; and
a second mode, wherein said white filter rotates at a third speed, and said third speed is slower than said first speed.

12. The projection-type display apparatus of claim 11, wherein said control modes further comprises:
a warm color mode, wherein said red filter rotates at a speed slower than said green filter, said white filter, and said blue filter do; and
a cold color mode, wherein said red filter rotates at a speed faster than said green filter, said white filter, and said blue filter do.

13. The projection-type display apparatus of claim 11, wherein said color separation device comprises a color wheel.

14. The projection-type display apparatus of claim 11, wherein said color separation device comprises a color drum.

15. A method for adjusting an image output by a display apparatus, said display apparatus having a color separation device comprising a plurality of filters, comprising:
providing a light beam incident on said color separation device so as to selectively form a plurality of chromatic lights corresponding to said filters; and
driving said color separation device to control a rotation speed of a predetermined one of said filters so that at least two filters rotate at different speeds when spinning through said light beam.

16. The method of claim 15, wherein said filters comprises at least one white filter and at least one chromatic filter, and said rotation speed of said white filter is increased when said light beam is incident on said white filter so as to form an image with enhanced color saturation.

17. The method of claim 15, wherein said filters comprises at least one white filter and at least one chromatic filter, and said rotation speed of said white filter is decreased when said light beam is incident on said white filter so as to form an image with enhanced brightness.

18. The method of claim 15, wherein said filters comprises at least one red filter, and said rotation speed of said red filter is increased when said light beam is incident on said red filter so as to form an image of cold color.

19. The method of claim 15, wherein said plurality of filters comprises a red filter, and said rotation speed of said red filter is decreased when said light beam is incident on said red filter so as to form an image of warm color.

20. The method of claim 15, wherein said color separation device is selected from a group consisting of a color wheel and a color drum.
